(19) United States
(12) Patent Application Publication
(10) Pub. No.: US 2022/0252794 A1
(43) Pub. Date: Aug. 11, 2022

(54) OPTICAL MODULE, RECEPTACLE EQUIPPED WITH ISOLATOR, AND OPTICAL UNIT

(71) Applicant: KYOCERA Corporation, Kyoto-shi, Kyoto (JP)

(72) Inventors: Tomoyoshi AKASHI, Kitami-shi (JP); Michifumi SHODA, Soraku-gun (JP)

(73) Assignee: KYOCERA Corporation, Kyoto-shi, Kyoto (JP)

(21) Appl. No.: 17/613,515

(22) PCT Filed: May 28, 2020
(86) PCT No.: PCT/JP2020/021180

§ 371 Date: Nov. 23, 2021

(30) Foreign Application Priority Data
May 29, 2019 (JP) 2019-100407

(51) Int. Cl. G02B 6/38

(52) U.S. Cl. CPC G02B 6/3812; G02B 6/3885; G02B 27/30; G02B 6/3853; G02B 6/3829; G02B 6/3854

(57) ABSTRACT

An optical module according to the present invention is provided with: a first ferrule that has a first collimator lens; a second ferrule that has a second collimator lens; and a polarization independent opt-isolator disposed between the first and second ferrules. A receptacle equipped with an isolator according to the present invention is provided with the optical module, and a receptacle connected to the optical module. An optical unit according to the present invention is provided with the receptacle equipped with the isolator, and an external substrate connected to the receptacle equipped with the isolator.

### CROSS REFERENCE TO RELATED APPLICATIONS

This application claims benefit of priority of Japanese Patent Application No. 2019-100407 filed on May 29, 2019. The entire disclosure of the application is incorporated herein by reference.

### TECHNICAL FIELD

The present disclosure relates to an optical module, a receptacle with an isolator, and an optical unit using a polarization-independent optical isolator which is used in optical communications and the like and which has a function of reducing return light from an external source.

### BACKGROUND

Semiconductor lasers (hereinafter referred to as LDs) are used in optical communication systems and optical measurement systems. In use of LDs, a part of light is reflected. It is known that an LD is damaged by incidence of return light, which is reflected light, into an active layer of the LD. It is known that collapse of an internal interference state causes defects such as wavelength shift and power fluctuation. To protect LDs from return light, and to realize high-precision measurement, high-speed modulation communication, and high density, optical isolators with a function of passing light in a forward direction and reducing return light are utilized.

Optical isolators can be broadly classified into polarization-dependent optical isolators and polarization-independent optical isolators based on difference in method of reducing return light. The polarization-dependent optical isolator transmits polarized light with a specific polarization plane in a forward direction. The polarization-dependent optical isolator reduces generation of return light by rotating the polarization plane. On the other hand, a polarization-independent optical isolator separates polarized light into normal and abnormal light without being affected by a polarization plane. The polarization-independent optical isolator uses difference between their optical paths to transmit a polarization component of light in a forward direction and to reduce return light. The latter polarization-independent optical isolator is not affected by a polarization plane, so it has low insertion loss and a versatile structure. An example in which a polarization-independent optical isolator is used in an optical communication system is disclosed in Patent Literature 1 (JP H11-174382A).

### SUMMARY

An optical module of the present disclosure includes:

a first ferrule having a first collimator lens;

a second ferrule having a second collimator lens; and

a polarization-independent optical isolator between the first ferrule and the second ferrule.

A receptacle equipped with the isolator of the present disclosure includes:

an optical module having the above configuration; and

a receptacle connected to the optical module.

An optical unit of the present disclosure includes:

the receptacle equipped with the isolator having the above configuration; and

an external substrate connected to the receptacle equipped with the isolator.

### BRIEF DESCRIPTION OF DRAWINGS

FIG. 1 is a perspective view of an optical module according to a first embodiment of the present disclosure.

FIG. 2 is a cross-sectional view of the optical module according to the first embodiment of the present disclosure.

FIG. 3 is a cross-sectional view of an optical module according to a second embodiment of the present disclosure.

FIG. 4 is a cross-sectional view of an optical module according to a third embodiment of the present disclosure.

FIG. 5 is a perspective view of an isolator-equipped receptacle according to a fourth embodiment of the present disclosure.

FIG. 6 is a cross-sectional view of the isolator-equipped receptacle according to the fourth embodiment of the present disclosure.

FIG. 7 is a perspective view of an optical unit according to a fifth embodiment of the present disclosure.

### DESCRIPTION OF EMBODIMENTS

Embodiments will be described in detail below using the drawings.

Configuration of Optical Module 1

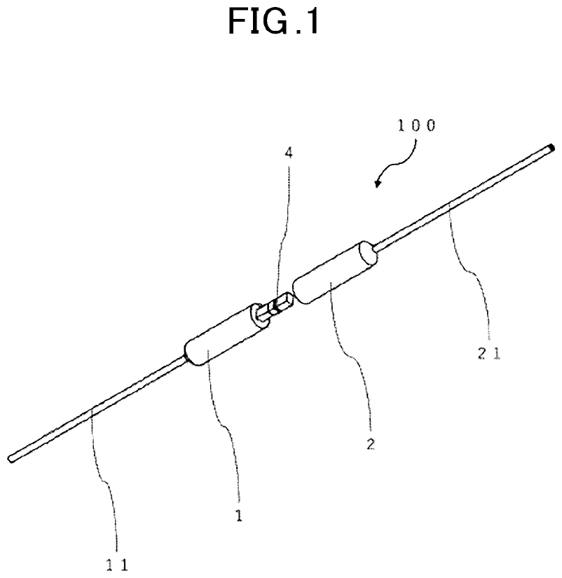

As shown in FIG. 1, an optical module 10 of the present disclosure includes a first ferrule 1, a second ferrule 2, and a polarization-independent optical isolator 3.

The first ferrule 1 has, for example, a cylindrical shape or a square cylindrical shape. For example, a diameter of the first ferrule 1 is 0.3 mm to 2.5 mm, and a length is 2.0 mm to 10 mm. In FIG. 1, the signs 11 and 12 indicate optical fibers.

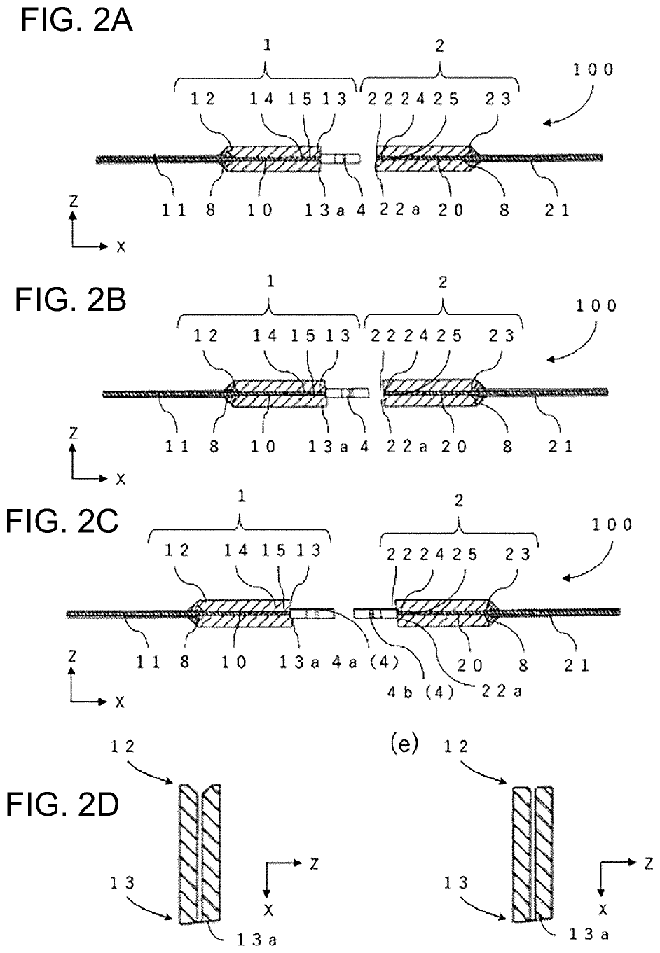

As shown in FIG. 2, the first ferrule 1 includes a first end 12, a second end 13, and a first through hole 10 through the first end 12 and the second end 13. A direction of a light path is the X-axis direction in FIG. 2. Light from an external light source, such as an LD, enters an opening at the first end 12, passes through the first through hole 10, and is emitted from an opening at the second end 13. The light from the external light source, such as an LD, may directly enter the first through hole 10 or may enter the first through hole 10 via the optical fiber 11. Drawings (a) to (c) in FIG. 2 show examples where the first collimator lens 14 is provided near the second end 13 in the first through hole 10. Thus, the first ferrule 1 of the optical module 100 of the present disclosure has the first collimator lens 14. The first collimator lens 14 outputs a substantially parallel luminous flux.

Materials of the first ferrule 1 are zirconia ceramics, alumina ceramics, and glass. For example, zirconia ceramics are ceramics that contain zirconia (ZrO2) as a main component. The main component accounts for 80 mass % or more of the 100 mass % of all components of ceramics. The same can be said for the alumina ceramics. In a case where the material of the first ferrule 1 is zirconia ceramics, mechanical strength is high, and wear resistance is excellent. It allows long lasting use. In a case where the material of the first ferrule 1 is glass, it can be visually checked whether the first collimator lens 14 or the like in the first through hole 10 is at a correct position.

In a case where the first ferrule 1 has a cylindrical shape, the first through hole 10 may be concentric to the outer shape and may extend in a straight line. In such a configuration, an optical axis can be adjusted without taking into account a position of the through hole relative to the outer shape and a direction in which the through hole extends. An optical axis of light passing through the first through hole 10 is easily adjusted.

In a case where the optical fiber 11 is used for inserting an external light source into the first through hole 10, an optical fiber having an outer diameter of 125 μm specified by JIS standard or TIA/EIA standard may be used. A diameter of the first through hole 10 can be determined appropriately for values specified in those standards. The diameter of the first through hole 10 is, for example, from 0.08 mm to 0.128 mm, and depends on a diameter of a fiber to be used. The optical fiber 11 is, for example, a quartz-based optical fiber, a plastic-based optical fiber, and a multi-component glass-based optical fiber. The optical fiber 11 is inserted into the first through hole 10 from the first end 12 side of the first ferrule 1. The optical fiber 11 is fixed to the first ferrule 1 by filling the first through hole 10 with adhesive 8.

The adhesive 8 is, for example, an acrylic resin, an epoxy resin, a vinyl resin, an ethylene resin, a silicone resin, a urethane resin, a polyamide resin, a fluorine resin, a polyptadiene resin, or a polycarbonate resin. Among those materials, the acrylic resin and the epoxy resin excel in moisture resistance, heat resistance, peeling resistance and impact resistance.

As shown in (d) of FIG. 2, the first end 12 of the first ferrule 1 may have a tapered shape in which an opening side is wider relative to an interior of the first ferrule 1 in a cross-sectional view in the X-axis direction. As shown in (e) of FIG. 2, an edge of the opening on the first end 12 side may have a round shape. In such a configuration, the first collimator lens 14 and the optical fiber 11 are easily inserted into the first through hole 10. The adhesive 8 for fixing the optical fiber 11 is easily inserted. The first collimator lens 14 is inserted into the first through hole 10 after being connected to the optical fiber 11 in advance. Therefore, in the first through hole 10, the optical fiber 11 and the first collimator lens 14 are arranged in this order in the direction of the light path. In that state, the first collimator lens 14 may be positioned at an opening of the second end 13.

For example, as shown in (a) of FIG. 2, a first surface 13a of the second end 13 of the first ferrule 1 may be flat. The first surface 13a is a surface near the second ferrule 2. In the case where the first surface 13a is flat, the polarization-independent optical isolator 4 is easy to be installed. The first surface 13a may be a plane inclined to a direction of light travel. The plane inclined to the direction of light travel is, for example, a plane inclined in a range of 2° to 12° to the Z-axis direction, which is a direction perpendicular to the X-axis direction, in a cross-sectional view in the X-axis direction, as shown in (b) in FIG. 2. In the case where the first surface 13a is a plane inclined to the direction of light travel, an optical axis of light reflected on the first surface 13a is inclined. Accordingly, the light reflected on the first surface 13a is rarely coupled to a third core 11a of the first optical fiber 11 to become return light.

A first transparent member 15 may be connected to the first collimator lens 14. In that case, the first collimator lens 14 and the first transparent member 15 may be arranged in this order in the X-axis direction in the first through hole 10. The first transparent member 15 may be located at the opening of the second end 13. In the case where the first transparent member 15 is located at the opening of the second end 13, it is difficult for powder caused by grinding to enter the first through hole 10 while the first surface 13a is formed by grinding the second end 13. Since there is little absorption or reflection of light powder that comes inside, loss of light intensity is unlikely to occur. The first collimator lens 14 and the first transparent member 15 may be connected by the adhesive 8 or may be fused by heat treatment.

A material of the first transparent member 15 may be glass. In such a configuration, if acrylic resin or epoxy resin is used as the adhesive 8 to bond the polarization-independent optical isolator 4 to the first surface 13a, refractive indices of the glass and the acrylic resin or epoxy resin are close to each other. Therefore, reflected light is hardly generated between the glass and the adhesive 8.

The first collimator lens 14 is capable of obtaining a substantially parallel luminous flux. In a case where the first collimator lens 14 is located within the first through hole 10, for example, a graded-index (GI) multimode optical fiber can be used as the first collimator lens 14. A refractive index of the GI multimode optical fiber is continuously changing. Distribution of the refractive index produces output of substantially parallel light. Thus, the GI multimode optical fiber functions as a collimator lens. Therefore, the optical module 100 can be made smaller in the case where the GI multimode optical fiber is used than in a case where a collimator lens is placed. In a case where the first collimator lens 14 is the GI multimode optical fiber and where the first transparent member 15 is glass, refractive indices of the GI multimode optical fiber and the glass are close to each other. Therefore, reflected light and return light is less likely to be generated.

A shape, size and materials of the second ferrule 2 are the same as those described above for the first ferrule 1. Explanation is omitted. As shown in FIG. 2, the second ferrule 2 includes a third end 22, a fourth end 23, and a second through hole 20 through the third end 22 and the fourth end 23. Light enters an opening at the third end 22, passes through the second through hole, and is emitted from an opening at the fourth end 23. Drawings (a) to (c) in FIG. 2 show examples where a second collimator lens 24 is provided near the third end 22 in the second through hole 20. Thus, the second ferrule 2 of the optical module 100 of the present disclosure has the second collimator lens 24.

A shape of the second through hole 20 is the same as described above for the first through hole 10. Explanation is omitted.

Like the first end 12 shown in (d) of FIG. 2, the fourth end 23 of the second ferrule 2 may have a tapered shape in which an opening side is wider relative an interior of the second ferrule 2. An edge of the opening on the fourth end 23 side may have a round shape, as in the first end 12 shown in (e) of FIG. 2. In such a configuration, the second collimator lens 24 and the optical fiber 21 are easily inserted into the second through hole 20. The adhesive 8 for fixing the optical fiber 21 is easily inserted. The second collimator lens 24 is inserted after being connected to the optical fiber 21 in advance. Therefore, in the second through hole 20, the second collimator lens 24 and the optical fiber 21 are arranged in this order in the direction of light travel. In that case, the second collimator lens 24 may be located at an opening of the third end 22.

The second surface 22a at the third end 22 of the second ferrule 2 may be flat as shown in (a) in FIG. 2, for example. The second surface 22a is near the first ferrule 1. In a case where the second surface 22a is flat, the polarization-independent optical isolator 4 is easily installed. The second surface 22a may be a plane inclined to the direction of light travel. The plane inclined to the direction of light travel is, for example, a plane inclined in a range of 2° to 12° to the Z-axis direction, which is a direction perpendicular to the X-axis direction, in a cross-sectional view in the X-axis direction, as shown in (b) of FIG. 2. In the case where the second surface 22a is a plane inclined to the direction of light travel, an optical axis of light reflected on the second surface 22a is inclined. Accordingly, the light reflected on the second surface 22a is rarely coupled to the first optical fiber 11 to become return light.

The second transparent member 25 may be connected to the second collimator lens 24. In that case, the second transparent member 25 and the second collimator lens 24 may be arranged in this order in the X-axis direction in the second through hole 20. The second transparent member 25 may be located at the opening of the third end 22. In the case where the second transparent member 25 is located at the opening of the third end 22, it is difficult for powder caused by grinding to enter the second through hole 20 while the second surface 22a is formed by end-face machining on the third end 22. Since there is little absorption or reflection of light by powder that comes inside, loss of light intensity is unlikely to occur. The second collimator lens 24 and the second transparent member 25 may be connected by the adhesive 8 or may be fused by heat treatment.

A material of the second transparent member 25, the second collimator lens 24 and the optical fiber 21 are the same as those described above for the first transparent member 15, the first collimator lens 14 and the optical fiber 11. Explanation is omitted.

The first ferrule 1 and the second ferrule 2 may be independent of each other. In that case, an optical axis can be adjusted by moving the second ferrule 2 such that light emitted from the opening of the first through hole 10 on the second end 13 side in the first ferrule 1 enters the second through hole 20. The first surface 13a in the first ferrule 1 and the second surface 22a in the second ferrule 2 may or may not be parallel.

The optical axis can be adjusted by arranging the first surface 13a in the first ferrule 1 and the second surface 22a in the second ferrule 2 in parallel in a case where:

the first through hole 10 in the first ferrule 1 is concentric to the outer shape and extends in a straight line;

the second through hole 20 in the second ferrule 2 is concentric to the outer shape and extends in a straight line; and

an angle between the first surface 13a and the first through hole 10 and an angle between the second surface 22a and the second through hole 20 are adjusted to be the same.

Manufacturing Method of Ferrule

An example of a manufacturing method of the first ferrule 1 will be described below. In the example, the material of the first ferrule 1 is zirconia ceramics having zirconia as the main component. A manufacturing method for the second ferrule 2 is the same as the manufacturing method of the first ferrule 1.

First, a mixture of zirconium oxide powder and yttrium oxide powder is thoroughly mixed and ground in a ball mill or the like. Binder is then added to this pulverized material and mixed. The result is a molding material. For example, out of 100 mass % of the mixed powder, 85 to 99 mass % is the zirconium oxide powder, and 1 to 15 mass % is the yttrium oxide powder. Alternatively, out of 100 mass % of the mixed powder, 90 to 99 mass % is the zirconium oxide powder, and 1 to 10 mass % is the yttrium oxide powder. Alternatively, 95 to 99 mass % is the zirconium oxide powder, and 1 to 5 mass % is the yttrium oxide powder.

A molded body having a shape which is nearly the final shape and which has a through hole is then formed using the prepared molding material. Specifically, the molding material is filled into a cavity of a molding mold where the shape which is nearly the final shape will be obtained. The molded body is obtained by press molding at a predetermined pressure. A method for obtaining the molded body is not limited to the press molding. Methods such as injection molding, casting, cold hydrostatic molding or extrusion may be employed.

A sintered body is then obtained by sintering the obtained molded body. Specifically, the obtained molded body is put into a dewaxing furnace at 500 to 600° C. for 2 to 10 hours to dewax. A sintered body is then obtained by sintering the dewaxed molded body at 1300 to 1500° C. for 0.5 to 3 hours in an oxygen atmosphere.

Next, the first end 12, the second end 13 and the first through hole 10 are formed by applying a grinding process or the like to an outer circumference of the obtained sintered body and an inner circumferential surface of the through hole. Specifically, machining is performed by pressing a grinding wheel against the sintered body while rotating it. In this machining, if an abrasive oil is used, grinding can be performed while minimizing increase in roughness of a ground surface. Thus, the first ferrule 1 is manufactured.

Next, the polarization-independent optical isolator 4 has a prismatic shape, for example. An end face may be an inclined plane.

In a case where the polarization-independent optical isolator 4 is installed at the second end 13, it is preferable that:

the first through hole 10 in the first ferrule 1 is concentric to the outer shape and extends in a straight line;

the first surface 13a of the second end 13 is inclined; and

the end face of the polarization-independent optical isolator 4 is inclined so as to be parallel to the first surface 13a.

It facilitates the polarization-independent optical isolator to be placed on the first surface 13a. The polarization-independent optical isolator 4 has a size that fits into an installation surface of, for example, 0.2 mm to 1.5 mm in length and 0.2 mm to 1.5 mm in width. The length in the optical axis direction falls in a range of 1.0 mm to 2.5 mm.

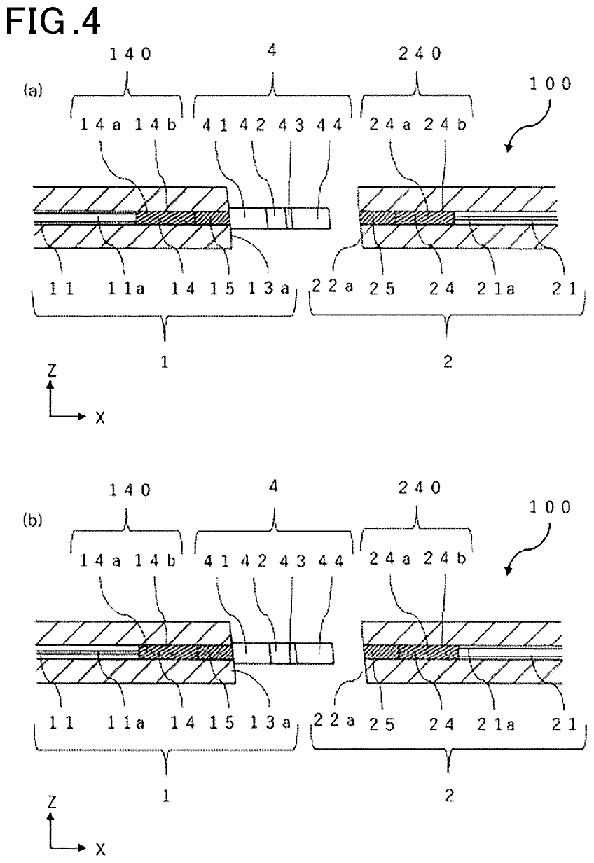

As shown in (a) and (b) of FIG. 4, the polarization-independent optical isolator 4 comprises a first birefringent crystal 41, a Faraday rotator 42, a half-wave plate 43, and a second birefringent crystal 44, which are bonded together. In that state, the Faraday rotator 42 and the half-wave plate 43 are sandwiched between the first birefringent crystal 41 and the second birefringent crystal 44. In the direction of the light path, either the Faraday rotator 42 or the half-wave plate 43 may be positioned in front of the other. Anti-reflection materials may be located between the first birefringent crystal 41, the Faraday rotator 42, the half-wave plate 43, and the second birefringent crystal 44. They reduce light reflected on surfaces (interfaces) of boundaries between the components. Although the anti-reflective materials are provided at the interfaces, signs are not given in the figure to avoid complication of the figure.

The polarization-independent optical isolator 4 is located:

on a path of light emitted from the opening of the first through hole 10 on the second end 13 side; and

the second end 13 of the first ferrule 1 or the third end 22 of the second ferrule 2.

The polarization-independent optical isolator 4 may be bonded to the second end 13 or the third end 22 with the adhesive 8.

There is little light reflected on an interface in a case where difference in refractive index is small between:

the adhesive 8 and the polarization-independent optical isolator 4; and

a collimator lens and an optical fiber in an opening on a side where the polarization-independent optical isolator 4 is located.

An anti-reflective material may be provided:

between the first ferrule 1 and the polarization-independent optical isolator 4;

in the polarization-independent optical isolator 4; and

between the second ferrule 2 and the polarization-independent optical isolator 4.

In such a configuration, there is little light reflection. The anti-reflective material is, for example, titanium dioxide (TiO2), silicon dioxide (SiO2) or tantalum pentoxide (Ta2O5).

The Faraday rotator 42 used in the polarization-independent optical isolator 4 is, for example, a Bi-substituted garnet doped with Tb, Gd, or Ho, a yttrium iron garnet (YIG), or a self-bias type rotator that does not require a magnet 45 described below.

The first birefringent crystal 41 and the second birefringent crystal 44 of the polarization-independent optical isolator 4 are, for example, rutile, yttrium vanadate (YVO4), calcite (CaCO3), and α-BBO crystals. The half-wave plate 43 is, for example, a crystal or a sapphire. Although examples of materials are shown, materials are not limited to them. Those with similar functions can be used.

As shown in (c) of FIG. 2, a first polarization-independent optical isolator 4a and a second polarization-independent optical isolator 4b may be located at the second end 13 and the third end 2 of the polarization-independent optical isolator 4, respectively. In that case, the first polarization-independent optical isolator 4a and the second polarization-independent optical isolator 4b need not be in contact with each other.

In the case where the first polarization-independent optical isolator 4a and the second polarization-independent optical isolator 4b are positioned in such a way, a distance between the third core 11a of the optical fiber 11 and light separated into normal light and abnormal light becomes longer in the direction opposite to the direction of the light path, which is a direction in which reflected light travels. It has excellent optical properties because it exhibits excellent isolation effect. The second polarization-independent optical isolator 4b should be arranged such that light separation direction is rotated by 90° with respect to the first polarization-independent optical isolator 4a.

In this case, reflected light is unlikely to enter the first through hole 10. It further reduces the return light.

Manufacturing Method of Polarization-Independent Optical Isolator

An example of a manufacturing method of a polarization-independent optical isolator 4 will be described below. First, optical adjustment is performed using a large half-wave plate and birefringent crystals. Substrates are then bonded to each other with the adhesive 8 and cutting is performed. Thus, the polarization-independent optical isolator 4 is manufactured. A large number of polarization-independent optical isolators can be readily manufactured in this manner.

Polarization-independent optical isolators with inclined end faces are manufactured by cutting the substrates while tilting them in a predetermined direction in advance. Thus, the polarization-independent optical isolator having an inclined plane that matches a shape of an end face of a ferrule is made.

In a case where the polarization-independent optical isolator 4 is located at the second end 13, the magnet 45 may be located at an outer circumference of the polarization-independent optical isolator 4 along the direction of the light path in the first through hole 10. In a case where the magnet 45 is located in such a way and where the Faraday rotator 42 is not self-biased but is constituted by Bi-substituted garnet or YIG, Faraday effect is achieved. That is, a polarization plane rotates when linearly polarized light is transmitted through a material in a direction of travel parallel to a magnetic field. Thus, the magnet 45 applies a magnetic field to the polarization-independent optical isolator 4.

The magnet 45 can be any as long as it can apply a magnetic field to the polarization-independent optical isolator 4. For example, the magnet 45 may be bonded to the second end 13 or the third end 22 with the adhesive 8. The magnet 45 may be bonded with the adhesive 8 to (i) an inner circumference or an end of a first holder 61 holding the first ferrule 1, (ii) an inner circumference or an end of a second holder 62 holding the second ferrule 2, and (iii) an inner circumference of a third sleeve 65, which will be described later.

A shape of the magnet 45 may not be cylindrical, and may also be rod-shaped. In a case where it is cylindrical, a magnetic field can be applied to the polarization-independent optical isolator 4 from a circumferential direction.

The magnet 45 is preferably samarium-cobalt-based (SmCo-based). If the magnet 45 is SmCo-based, it has a high Curie temperature and high heat resistance.

Therefore, magnetism of the magnet 45 is unlikely to degrade even after heat treatment is performed.

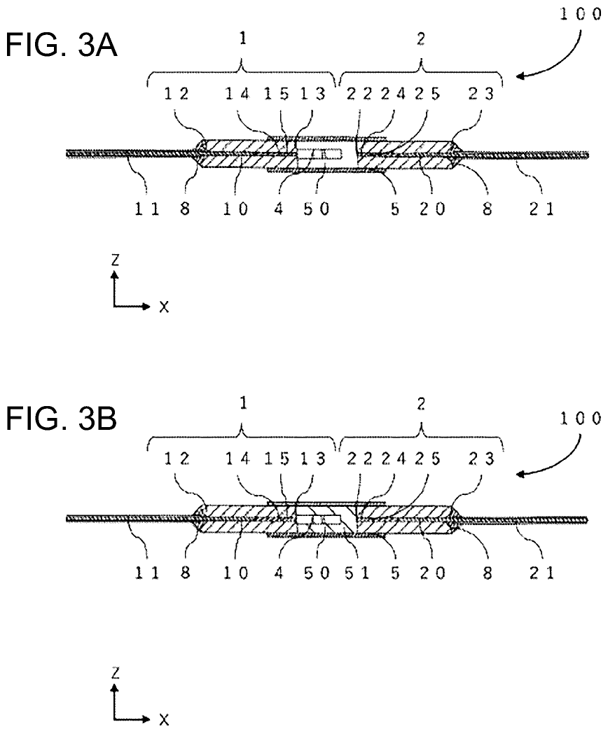

In the second embodiment shown in FIG. 3, the optical module 100 may include a first sleeve 5 having a third through hole 50 where the second end 13 of the first ferrule 1, the polarization-independent optical isolator 4, and the third end 22 of the second ferrule 2 are located.

In a case where:

the first through hole 10 in the first ferrule 1 is concentric to the outer shape and extends in a straight line; and

the second through hole 20 in the second ferrule 2 is concentric to the outer shape and extends in a straight line,

optical axes are aligned by:

connecting an outer circumference of the first ferrule 1 to one end of the third through hole 50; and

connecting an outer circumference of the second ferrule 2 from an opposite end of the third through hole 50.

To connect the third through hole 50 with the first and second ferrules 1, 2, the adhesive 8 may be used while the first and second ferrules 1, 2 are fitted into the third through hole 50. The adhesive 8 may be used after the first and second ferrules 1, 2 are fitted into the third through hole 50. It improves connection strength between the third through hole 50 and the first and second ferrules 1, 2.

In the case where the first sleeve 5 is provided as in the second embodiment of FIG. 3, a magnet may be bonded to an outer circumference of the first sleeve 5 with the adhesive 8. A magnet may be bonded to an inner circumference of the first sleeve 5 with the adhesive 8.

A material of the first sleeve 5 is zirconia ceramics or the like. In a case where the material of the first sleeve 5 is zirconia ceramics, mechanical strength is high and wear resistance is excellent. It allows long lasting use.

As shown in (b) in FIG. 3, a resin material 51 may be located in a space between the second end 13 and the third end 22 in the third through hole 50 of the first sleeve 5. The resin material 51 is, for example, an acrylic resin, an epoxy resin, a vinyl resin, an ethylene resin, a silicone resin, a urethane resin, a polyamide resin, a fluorine resin, a polyptadiene resin, and a polycarbonate resin. Among those materials, the acrylic resin and the epoxy resin excel in moisture resistance, heat resistance, peeling resistance and impact resistance. In a case where the resin material 51 is located in a region within the first sleeve 5, the resin material 51 has a refractive index close to that of, for example, the second transparent member 25 which is present in the direction of the light travel. Accordingly, reflection at an interface can be suppressed without providing an anti-reflection material on the second transparent member 25.

As in the third embodiment shown in FIG. 4, the first collimator lens 14 may be a first optical fiber 140 having a first core 14a and a first clad 14b. The second collimator lens 24 may be a second optical fiber 240 having a second core 24a and a second clad 24b. The first optical fiber 140 and the second optical fiber 240 are GI multimode optical fibers. The first ferrule 1 further includes an optical fiber 11 which is located in the first through hole 10 and which has a third core 11a (Hereafter referred to as a third optical fiber in the description about FIG. 4). The third optical fiber 11 and the first optical fiber 140 are arranged in this order in the direction of the light path in the first through hole 10. The second ferrule 2 further includes an optical fiber 21 which is located in the second through hole 20 and which has a fourth core 21a (Hereafter referred to as a fourth optical fiber in the description about FIG. 4). The second optical fiber 240 and the fourth optical fiber 21 are arranged in this order in the direction of the light path in the second through hole 20. A core diameter of the third core 11a is smaller than a core diameter of the fourth core 21a ((b) in FIG. 4). Further, a difference in refractive index between the first core 14a and the first clad 14b may be larger than a difference in refractive index between the second core 24a and the second clad 24b. Alternatively, a core diameter of the fourth core 21a is smaller than a core diameter of the third core 11a ((a) in FIG. 4). Further, a difference in refractive index between the first core 14a and the first clad 14b may be smaller than a difference in refractive index between the second core 24a and the second clad 24b. Thus, optical fibers with different mode field diameters (MFD) are connected. It reduces losses due to mismatch between MFDs.

Configuration of Isolator-Equipped Receptacle 6

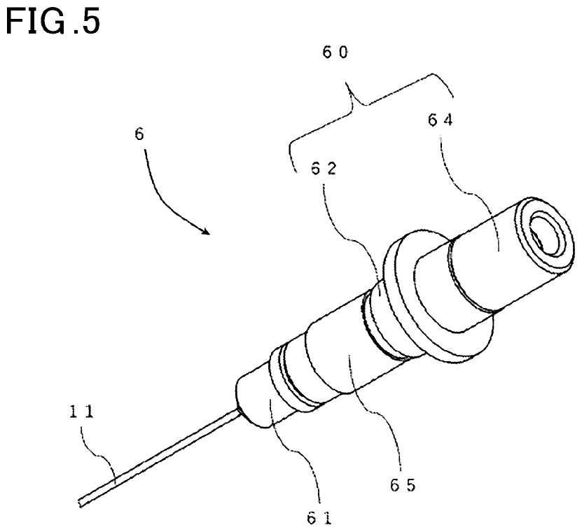

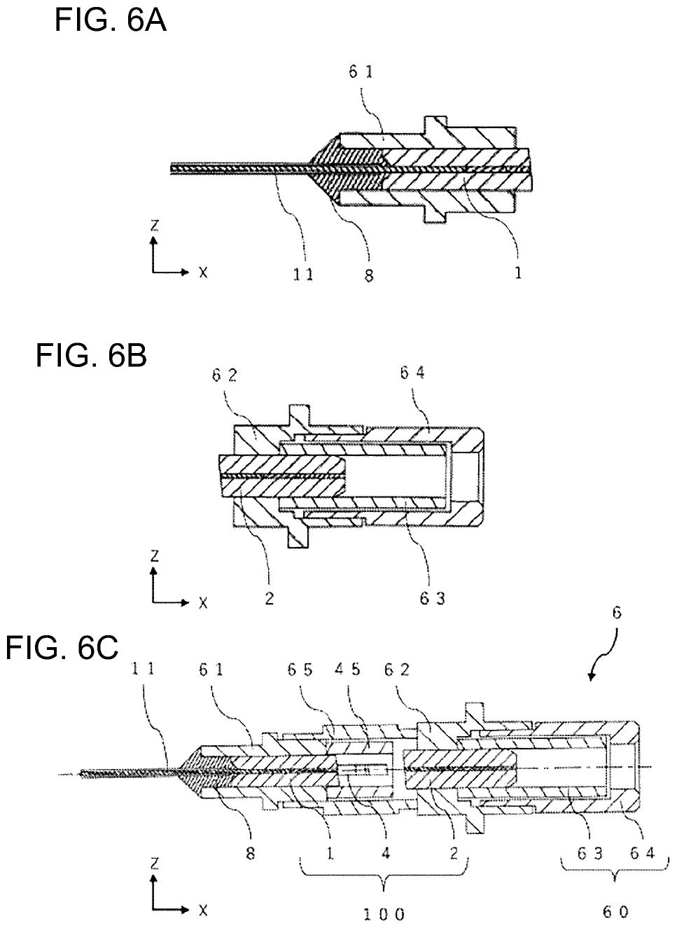

FIG. 5 is a perspective view of an isolator-equipped receptacle according to a fourth embodiment. FIG. 6 is a cross-sectional view of the isolator-equipped receptacle according to the fourth embodiment. Drawings (a) and (b) in FIG. 6 are partial cross-sectional views. An isolator-equipped receptacle 6 according to the fourth embodiment includes the optical module 100 and a receptacle 60.

The receptacle 6 includes:

a second sleeve 63 having a cylindrical shape; and

a sleeve case 64 that holds an outer circumference of the second sleeve 63.

The second sleeve 63 has, for example, a cylindrical shape and is made of zirconia ceramics. The sleeve case 64 has, for example, a cylindrical shape and is made of metal such as stainless steel, polybutylene terephthalate (PBT) resin, etc.

To connect the receptacle 60 to the optical module 100, the second ferrule 2 is first connected by inserting it into a through hole of the second sleeve 63 from the fourth end 23 side. In a case where the fourth end 23 has a convex shape, interference between an end of an external optical plug and the fourth end 23 is reduced. The fourth end 23 is easier to physically contact the external optical plug as compared with a case where it has a shape other than a convex. It improves reliability of connection between the isolator-equipped receptacle 6 and the external optical plug. An outer circumference of the second sleeve 63 is connected so as to be in contact with an inner circumference of the sleeve case 64. Next, the first ferrule 1 is inserted into a through hole of the first holder 61. The outer circumference of the first ferrule 1 contacts the inner circumference of the first holder 61. The first ferrule 1 is thus connected to the first holder 61. Outer circumferences of the second ferrule 2 and the sleeve case 64 are connected so as to be in contact with the inner circumference of the second holder 62. The first holder 61, in which the first ferrule 1 is held, and the second holder 62, in which the second ferrule 2 is held, are connected by a connector 65. Thus the isolator-equipped receptacle 6 is made. In order to connect the components, the components may be connected with the adhesive 8 or by YAG (yttrium aluminum garnet) welding.

The through holes in the first holder 61 and the second holder 62 should have a cylindrical shape from a viewpoint of ease of processing. In a case where the through hole in the first holder 61 has a cylindrical shape and where the first ferrule 1 also has a cylindrical shape, connection strength between the first holder 61 and the first ferrule 1 is increased. Misalignment of the optical axis due to loose connection between the first holder and the first ferrule 1 is reduced by tightly fitting and connecting them together. It increases optical reliability of the isolator-equipped receptacle 6. The same can be said for the second holder 62 and the second ferrule 2.

The first holder 61 and the second holder 62 are made of stainless steel, metal including stainless steel, or a resin such as PBT. If the first holder 61 and the second holder 62 are made of stainless steel, they are not easily deformed against stress received from outside. It allows long lasting use.

The third sleeve 65 may be arranged to hold an outer circumference of the first holder 61. After an optical axis of the second ferrule 2 is adjusted such that light emitted from the opening of the first through hole 10 on the second end 13 side enters the second through hole 20 of the second ferrule 2, the third sleeve 65 may be connected to an end of the second holder 62 with the adhesive 8. The optical axis is adjusted by moving the second ferrule 2 such that the light emitted from the opening of the first through hole 10 on the second end 13 side enters the second through hole 20. Thereby the isolator-equipped receptacle 6 having good optical characteristics is formed.

The third sleeve 65 is made of stainless steel, metal including stainless steel, or resin such as PBT. If the third sleeve 65 is made of stainless steel, it is not easily deformed against stress received from outside. It allows long lasting use.

Configuration of Optical Unit 7

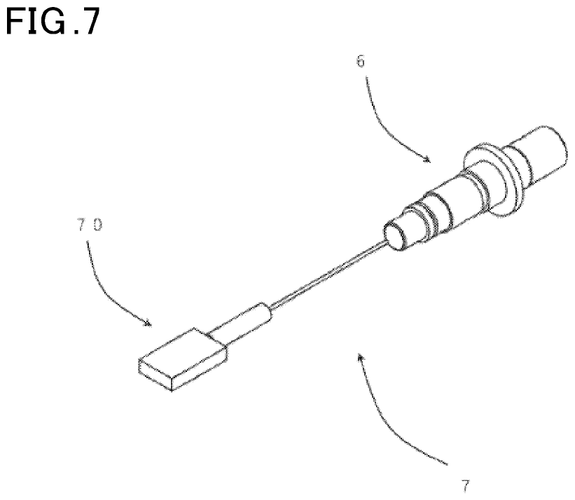

FIG. 7 is a perspective view of an optical unit according to a fifth embodiment of the present invention. In FIG. 7, an optical unit 7 according to the embodiment of the present invention includes the isolator-equipped receptacle 6 as described above and an external substrate 70.

The external substrate 70 in FIG. 7 is constituted by silicon photonics and is connected to the isolator-equipped receptacle 6 by the adhesive 8. In that state, an LD is placed on the external substrate 70. The isolator-equipped receptacle 6 includes the optical fiber 11. Light of the LD enters the first through hole 10. Thus the LD can be freely placed on the external substrate 70.

The optical module 100, the isolator-equipped receptacle 6, and the optical unit 7 equipped therewith of the embodiments are described above. The present invention is not limited to those embodiments. Various modifications and combination of embodiments are possible within the scope of the claims of the present invention.

### REFERENCE SIGNS LIST

100 optical module
1 first ferrule
10 first through hole
11 optical fiber (third optical fiber)
11a third core
12 first end
13 second end
14 first collimator lens
14a first core
14b first clad
140 first optical fiber
15 first transparent member
2 second ferrule
20 second through hole
21 optical fiber (fourth optical fiber)
21a fourth core
22 third end
23 fourth end
24 second collimator lens
24a second core
24b second clad
240 second optical fiber
25 second transparent member
4 polarization-independent optical isolator
4a first polarization-independent optical isolator
4b second polarization-independent optical isolator
41 first birefringent crystal
42 Faraday rotator
43 half-wave plate
44 second birefringent crystal
45 magnet
5 first sleeve
50 third through hole
51 resin material
6 isolator-equipped receptacle
60 receptacle
61 first holder
62 second holder
63 second sleeve
64 sleeve case
65 connector
7 optical unit
70 external substrate
8 adhesive

1. An optical module, comprising:
a first ferrule having a first collimator lens;
a second ferrule having a second collimator lens; and
a polarization-independent optical isolator between the first ferrule and the second ferrule.

2. The optical module according to claim 1, wherein the first ferrule includes a first surface which is near the second ferrule and which is inclined to a direction of light travel.

3. The optical module according to claim 1, wherein the second ferrule includes a second surface which is near the first ferrule and which is inclined to a direction of light travel.

4. The optical module according to claim 1, further comprising:
an anti-reflective material provided at least one of:
a position between the first ferrule and the polarization-independent optical isolator;
a position in the polarization-independent optical isolator; and
a position between the second ferrule and the polarization-independent optical isolator.

5. The optical module according to claim 1, further comprising:
a magnet that applies a magnetic field to the polarization-independent optical isolator.

6. The optical module according to claim 1, further comprising:
a resin material on an optical path between:
the first ferrule and the polarization-independent optical isolator; or
the second ferrule and the polarization-independent optical isolator.

7. The optical module according to claim 1, further comprising:
a first holder that holds the first ferrule;
a second holder that holds the second ferrule; and
a connector that connects the first holder and the second holder.

8. The optical module according to claim 1, wherein the first ferrule and the second ferrule are made of zirconia ceramics.

9. The optical module according to claim 1, wherein
the first collimator lens is a graded-index multimode first optical fiber having a first core and a first clad,
the second collimator lens is a graded-index multimode second optical fiber having a second core and a second clad,
the first ferrule has a third optical fiber having a third core, and the third optical fiber and the first optical fiber are arranged in this order in a direction of light path,
the second ferrule has a fourth optical fiber having a fourth core, and the second optical fiber and the fourth optical fiber are arranged in this order in the direction of the light path,
a core diameter of the third core is smaller than a core diameter of the fourth core, and
a difference in refractive index between the first core and the first clad is larger than a difference in refractive index between the second core and the second clad.

10. The optical module according to claim 1, wherein
the first collimator lens is a graded-index multimode first optical fiber having a first core and a first clad,
the second collimator lens is a graded-index multimode second optical fiber having a second core and a second clad,
the first ferrule has a third optical fiber having a third core, and the third optical fiber and the first optical fiber are arranged in this order in a direction of light path,
the second ferrule has a fourth optical fiber having a fourth core, and the second optical fiber and the fourth optical fiber are arranged in this order in the direction of the light path,
a core diameter of the fourth core is smaller than a core diameter of the third core, and
a difference in refractive index between the first core and the first clad is smaller than a difference in refractive index between the second core and the second clad.

11. A receptacle equipped with the isolator, comprising:
the optical module according to claim 1; and
a receptacle connected to the optical module.

12. An optical unit, comprising:
the receptacle equipped with the isolator according to claim 11; and
an external substrate connected to the receptacle equipped with the isolator.

13. The optical module according to claim 1, wherein
the first ferrule includes:
a first end; and
a second end which includes a first surface which is near the second ferrule, and
the first end has a tapered shape in which an opening side is wider relative to an interior of the first ferrule.

14. The optical module according to claim 1, wherein
the first ferrule includes a first transparent member, and
the first transparent member is connected to the first collimator lens.

15. The optical module according to claim 1, wherein
the second ferrule includes a second transparent member, and
the second transparent member is connected to the second collimator lens.
